(19) United States
(12) Patent Application Publication
(10) Pub. No.: US 2008/0127315 A1
(43) Pub. Date: May 29, 2008

(54) System and method for protecting copyrights of digital content

(75) Inventor: Yong Hyun Kim, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/982,026

(22) Filed: Oct. 31, 2007

(30) Foreign Application Priority Data
Nov. 23, 2006 (KR) 2006-0116178

(51) Int. Cl. G06F 21/20

(52) U.S. Cl. 726/5

(57) ABSTRACT

A system for protecting copyrights of digital content includes a digital content server for providing digital content containing an address of a digital content server, performing authentication of the digital content, and generating execution/non-execution information representing an authentication result for the digital content. A mobile terminal receives the execution/non-execution information from the digital content server and executes the digital content according to the execution/non-execution information. A method may include the steps of detecting an address of a digital content server contained in the digital content; accessing the digital content server using the detected address and transmitting identification (ID) information necessary for executing the digital content to the digital content server; performing authentication of the digital content in the digital content server using the ID information, and generating execution/non-execution information representing an authentication result for the digital content, and transmitting the execution/non-execution information to the mobile terminal.

### CLAIM OF PRIORITY

This application claims priority from an application entitled “SYSTEM AND METHOD FOR PROTECTING COPYRIGHTS OF DIGITAL CONTENT” filed in the Korean Intellectual Property Office on Nov. 23, 2006 and assigned Serial No. 2006-0116178, the contents of which are incorporated herein by reference.

### BACKGROUND OF THE INVENTION

1. Field of the Invention

The present invention relates to a system and method for protecting copyrights of digital content. More particularly, the present invention relates to a system and method for providing strengthened protection of digital content by performing digital content authentication by a digital content-providing server.

2. Description of the Related Art

As Internet usage has expanded, the rate of the exchange of files between users and/or servers containing copyrighted digital content of drama video files, movie files, television programs, books, video games and music in formats including but not limited to MP, AVI, RAM, MOV, QT, WMA, AIFF, AU, WAV, and RA have increased to such a degree that conventional outlets for authorized purchases of such material has been adversely impacted.

However, expanding Internet usage has also promoted illegal copying and downloading of digital content. In addition, the artists, who are often entitled to royalties from the purchases of such copyrighted material, are also not receiving the proper compensation for their creations. With the advent of wireless telephones that now permit the downloading and viewing of copyrighted material, the problem of unauthorized copying and file sharing is getting worse. Thus, copyright protection has emerged as a major issue.

To prevent such illegal activities, digital content providers have developed various techniques to protect copyright of digital content. One of the proposed techniques is to allow only an authenticated-user having an authentication key to use downloaded digital content.

However, one drawback of implementing the aforementioned technique, a Digital Rights Management (DRM) module available from the Open Mobile Alliance (OMA) normally needs to be embedded in a mobile terminal. Another drawback of the aforementioned technique is that the copyrighted digital content is made available through a web server but a license to use the digital content is downloaded from a license server, thus causing much inconvenience to the user. Accordingly, there is a long-felt need in the art for an effective system and method to protect the exchange of copyrighted material that does not discourage the user from compliance with the copyright laws because of burdensome, time-consuming steps when used.

### SUMMARY OF THE INVENTION

In order to solve the above problems, an aspect of the present invention is to provide a system and method for protecting copyrights of digital content that enables a digital content server to perform digital content authentication.

Another aspect of the present invention is to provide a system and method for protecting digital content of copyrighted material that can prevent illegal copying and hacking of digital content by enabling a digital content server to perform digital content authentication before the content can be used/viewed.

Another aspect of the present invention is to provide a system and method for protecting copyrighted digital content that enables a user to easily check copyrights of the digital content by enabling a digital content server to perform digital content authentication of downloaded copyrighted material.

In accordance with an embodiment of the present invention, a system is provided for protecting copyrights of digital content, including: a digital content server for providing digital content containing an address of a digital content server, performing authentication of the digital content, and generating execution/non-execution information representing an authentication result for the digital content; and a mobile terminal for receiving the execution/non-execution information from the digital content server and executing the digital content according to the execution/non-execution information.

In accordance with another embodiment of the present invention, a method is provided for protecting copyrights of digital content, including: detecting, upon receiving a request to execute the digital content in a mobile terminal, an address of a digital content server contained in the digital content; accessing the digital content server using the detected address and transmitting identification (ID) information necessary for executing the digital content to the digital content server; performing authentication of the digital content in the digital content server using the ID information, generating execution/non-execution information representing an authentication result for the digital content, and transmitting the execution/non-execution information to the mobile terminal; and receiving the execution/non-execution information in the mobile terminal and executing the digital content according to the execution/non-execution information.

In accordance with yet another embodiment of the present invention, a method is provided for protecting copyrights of digital content provided by a digital content server by executing the digital content in a mobile terminal, including: detecting, upon receiving a request to execute the digital content in the mobile terminal, an address of the digital content server contained in the digital content; accessing the digital content server using the detected address; receiving execution/non-execution information representing an authentication result for the digital content from the digital content server; and executing the digital content according to the execution/non-execution information.

### BRIEF DESCRIPTION OF THE DRAWINGS

The above features and advantages of the present invention will be more apparent from the following detailed description in conjunction with the accompanying drawings, in which:

FIG. 1 is a diagram illustrating a configuration of a system for protecting copyrights of digital content according to an embodiment of the present invention;

FIG. 2 is a block diagram illustrating a configuration of a mobile terminal for protecting copyrights of digital content according to an embodiment of the present invention;

FIG. 3 is a flowchart illustrating a method for protecting copyrights of digital content according to an embodiment of the present invention;

FIG. 4 is a flowchart illustrating an operation of a mobile terminal in a method for protecting copyrights of digital content according to another embodiment of the present invention;

FIG. 5 is a flowchart illustrating a method for protecting copyrights of digital content according to another embodiment of the present invention; and

FIG. 6 is a flowchart illustrating an operation of a mobile terminal in a method for protecting copyrights of digital content according to another embodiment of the present invention.

### DETAILED DESCRIPTION OF THE INVENTION

Hereinafter, embodiments of the present invention are described in detail with reference to the accompanying drawings. A person of ordinary skill in the art understands and appreciates that the following examples are provided for purposes of illustration and not limitation, and there are many ways the invention can be practiced other than the exemplary embodiments that are within the spirit of the invention and the scope of the appended claims. For example, although a mobile terminal capable of supporting the wireless Internet is used in the exemplary embodiments of the present invention, it will be obvious to those skilled in the art that the information provided to the mobile terminal may be any type of information and the mobile terminal may comprise any type of communication device that can provide convenience for users, including a mobile communication terminal capable of supporting the wireless Internet, mobile phone, thin client, Personal Digital Assistant (PDA), Smart Phone, and applications thereof.

Digital content stored in a mobile terminal according to an exemplary embodiment of the present invention means content including but not limited to video content, audio content, image content, and other digital information. The digital content may also be stored in an external memory card or downloaded through a wireless Internet such as Wireless Application Protocol (WAP) or Worldwide Web. An address of a digital content server contained in the digital content according to an exemplary embodiment of the present invention means an encrypted Uniform Resource Locator (URL) address of the digital content server.

In the embodiments described herein below, “execution/non-execution information” means an authentication result for digital content. “Execution authentication information” refers to information representing that the execution of digital content is authenticated by a digital content server. “Execution non-authentication information” refers to information representing that the execution of digital content is not authenticated (i.e. potentially unauthorized) by a digital content server.

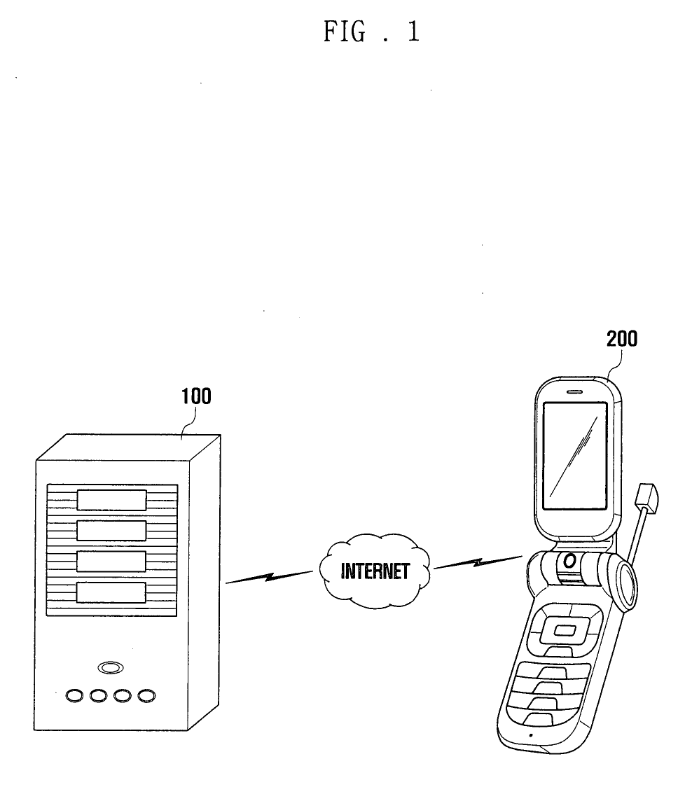

FIG. 1 is a diagram of a configuration of a system for protecting copyrights of digital content according to an embodiment of the present invention.

Referring to FIG. 1, the system includes a digital content server 100 and a mobile terminal 200, which typically communicate over the Internet, but a person of ordinary skill in the arts understands and appreciates that the invention is not limited according to the mode of communication between the digital content server 100 and the mobile terminal 200.

The digital content server 100 provides digital content containing an address of the digital content server 100 to the mobile terminal 200 and matches unique information of the digital content with unique information of the mobile terminal 200 received from the mobile terminal 200 for storage.

More specifically, upon receipt of identification (ID) information from the mobile terminal 200, the digital content server 100 determines whether unique information of a mobile terminal that is stored is identical to the unique information of the mobile terminal 200 by matching the unique information of the digital content with the unique information of the mobile terminal 200.

The digital content server 100 transmits execution/non-execution information about the digital content to the mobile terminal 200. The execution/non-execution information means execution authentication or non-authentication information representing whether execution of the digital content has been authenticated.

The mobile terminal 200 requests digital content from the digital content server 100, and downloads the requested digital content from the digital content server 100 for storage. Thereafter, upon receiving a request for execution of the digital content, the mobile terminal 200 detects an address of the digital content server 100 contained in the digital content and transmits ID information to the digital content server 100. Note that the address contained in the digital content the same address used to previously contact the server to request the download.

The mobile terminal 200 receives execution/non-execution information about the digital content from the digital content server 100 and determines whether the execution/non-execution information is execution authentication information or execution non-authentication information.

Still referring to FIG. 1, if the execution/non-execution information contains execution authentication information, the mobile terminal 200 executes the digital content.

However, if the execution/non-execution information contains execution non-authentication information, the mobile terminal 200 displays a message indicating that execution of the digital content is not authenticated.

One of the many advantages of the present invention is that by including the address of the digital content server 100 in the downloaded digital content, when the mobile terminal (via a user) subsequently desires to access the downloaded content, there is no need for the user to have to remember the address of the digital content server to request the execution/non-execution information.

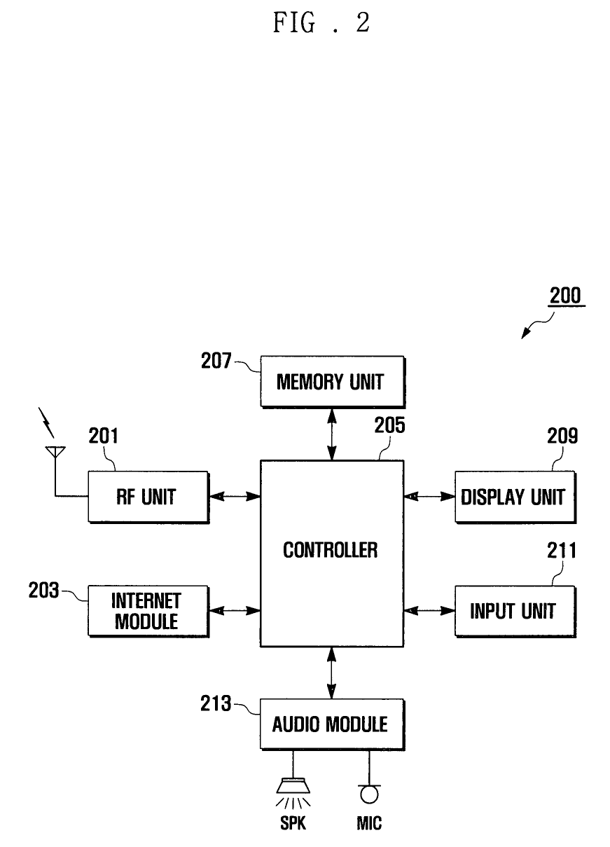

FIG. 2 is a block diagram illustrating a configuration of the mobile terminal 200 for protecting copyrights of digital content according to an exemplary embodiment of the present invention.

Referring to FIG. 2, the mobile terminal 200 according to the present embodiment includes a radio frequency (RF) unit 201, an Internet module 203, a controller 205, a memory unit 207, a display unit 209, an input unit 211, and an audio module 213.

The RF unit 201 performs typical wireless communications between the mobile terminal 200 and a mobile communication network. For example, the RF unit 201 transmits/receives voice data, text messages, and multimedia messages over the mobile communication network.

The Internet module 203 is controlled by the controller 205 to use the address of digital content server 100, which is contained in the digital content, in order to connect to the digital content server 100 to authenticate the digital content. The Internet module 203 receives the digital content containing the address of the digital content server 100 from the digital content server 100 and transmits the digital content to the controller 205.

The controller 205 controls the overall operations of all of the units that are part of the mobile terminal 200. In particular, the controller 205 includes a coder/decoder (codec) and a modulator/demodulator (modem) including a transmitter that encodes and modulates a signal for transmission and a receiver that demodulates and decodes a received signal. The controller 205 detects the address of the digital content server 100 contained in the digital content received from the Internet module 203 and controls the Internet module 203 to access the digital content server 100 to have the content information authenticated. The controller 205 also controls the Internet module 203 to transmit ID information stored in the memory unit 207 to the digital content server 100 and receives execution/non-execution information about the digital content from the digital content server 100.

Still referring to FIG. 2, the controller 205 determines whether the execution/non-execution information is execution authentication information (a genuine copy) or execution non-authentication information. If the information is execution authentication information, the controller 205 controls the display unit 209 and the audio module 213 to execute the digital content.

However, if the information is execution non-authentication information, the controller 205 controls the display unit 209 to display notification that the digital content is not executable. Accordingly, the controller executes only genuine copies, so the mobile terminal cannot be used to execute unauthorized content in violation of copyright protection afforded the digital content.

The memory unit 207 is also controlled by the controller 205 to store information related to operation of the mobile terminal 200, such as mode setting and menus. In addition, the memory unit 207 is controlled by the controller 205 to store digital content received from the digital content server 100.

With regard to the aforementioned paragraph, the memory unit 207 stores unique information of the mobile terminal 200 and ID information of the digital content. Moreover, the memory unit 207 also stores information about whether the digital content has been previously executed. The information is made available by checking whether execution/non-execution information about the digital content has been received from the digital content server 100.

Still referring to FIG. 2, the display unit 209 is controlled by the controller 205 to display operating states and operation results for units within the mobile terminal 200 and various other information. The display unit 209 may be a Liquid Crystal Display (LCD), Organic Light Emitting Diodes (OLED), or Plasma Display Panel (PDP), or any other type of display device. The display unit 209 is also controlled by the controller 205 to display video data in the digital content as well as displaying the operating states and results discussed above.

The input unit 211 typical includes a keypad. Alternatively, the input unit 211 may include a touch screen, a touch pad, and a scroll wheel. The input unit 211 receives user manipulation signals for controlling the operation of the mobile terminal 200 and outputs the signals to the controller 205.

The audio module 213 converts an analog audio signal input through a microphone MIC to a digital signal, and converts a digital audio signal output from the controller 205 to an analog audio signal and reproduces the signal through a speaker (SPK). That is, the speaker SPK is controlled by the controller 205 to play back audio data in the digital content.

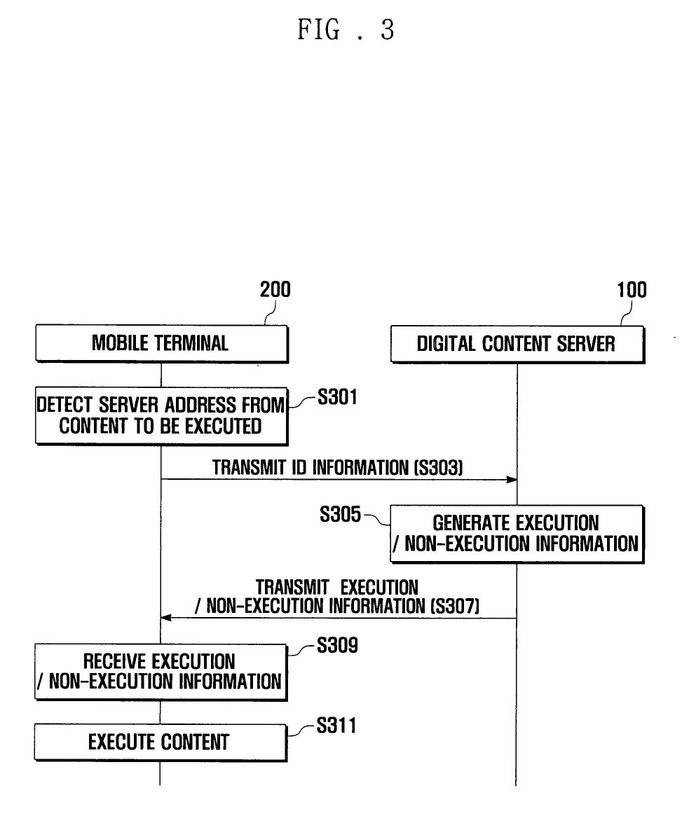

FIG. 3 is a flowchart illustrating a method for protecting copyrights of digital content according to another exemplary embodiment of the present invention. With regard to the flowchart in FIG. 3, it is assumed hereafter that digital content is already downloaded from the digital content server 100 and stored in the memory unit 207 of the mobile terminal 200 prior to performing step S301.

Referring to FIGS. 1 through 3, the controller 205 of the mobile terminal 200 receives a user command from the input unit 211 to execute digital content stored in the memory unit 207 and detects an address of the digital content server 100 contained in the digital content (S301).

The mobile terminal 200 accesses the digital content server 100 using the detected address and transmits ID information to the digital content server 100 (S303). In this case, the ID information may be unique information of the mobile terminal 200 to which the digital content is downloaded and unique information of the digital content.

The digital content server 100 performs authentication on the digital content using the ID information received from the mobile terminal 200 in the step S303 and generates execution/non-execution information (S305).

Still referring to FIG. 3, the digital content server 100 determines whether unique information of a mobile terminal that is stored in the digital content server 100 by matching with unique information of the digital content is identical to the unique information of the mobile terminal 200. Execution or non-execution of the digital content can be determined depending on whether the stored unique information of the mobile terminal 200 is identical to the unique information of the mobile terminal 200.

The digital content server 100 then transmits the execution/non-execution information representing whether execution of the digital content is authenticated to the mobile terminal 200 (S307). The mobile terminal 200 receives the execution/non-execution information from the digital content server 100 (S309) and, according to the execution/non-execution information, executes the digital content if the information transmitted in step S307 is authenticated (execution information) (S311).

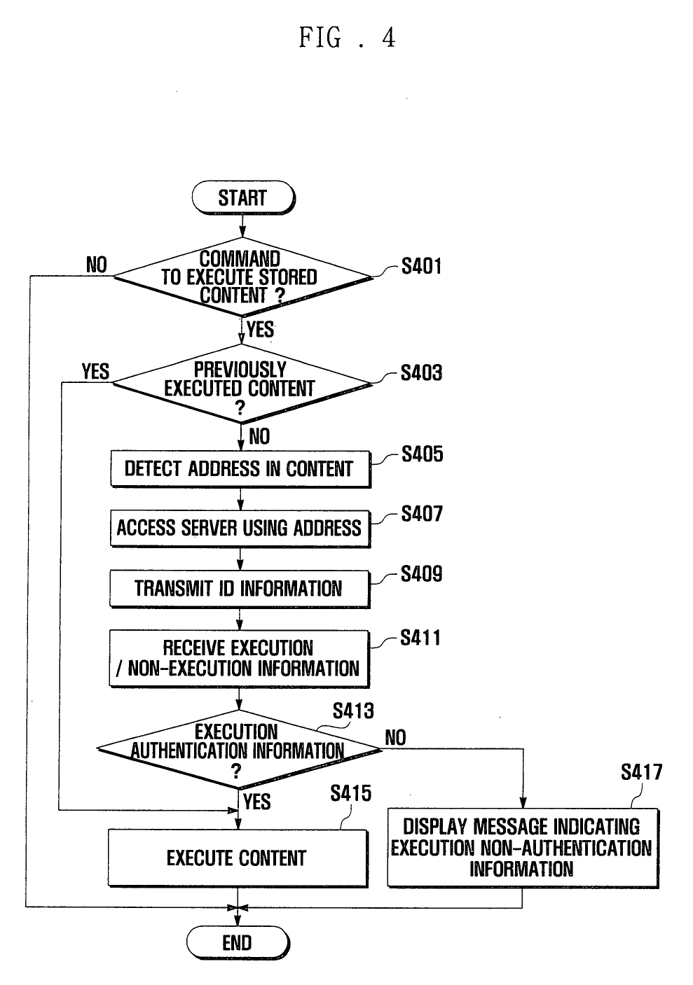

FIG. 4 is a flowchart illustrating an operation of a mobile terminal in a method for protecting copyrights of digital content according to another exemplary embodiment of the present invention.

Referring to FIGS. 1 through 4, if the controller 205 determines that a user command to execute the digital content stored in the memory unit 207 is input through the input unit 211 (S401), the controller 205 then determines whether the digital content to be executed has been previously executed (S403). If the controller 205 determines that the digital content has been previously executed, the controller 205 executes the digital content (S415) without further delay. The previously executed digital content means digital content for which execution authentication information has been received from the digital content server 100.

If the controller 205 determines at step (S403) that the digital content has not been previously executed, the controller 205 detects an address of the digital content server 100 contained in the digital content (S405).

The controller 205 then controls the Internet module 203 to access the digital content server 100 with the detected address (S407) and transmits ID information to the digital content server 100 (S409). Thereafter, the controller 205 controls the Internet module 203 to receive execution/non-execution information about the digital content (S411).

The controller 205 determines whether the execution/non-execution information is execution authentication information or execution non-authentication information (S413). If the execution/non-execution information is execution authentication information, the controller 205 controls the display unit 209 and the audio module 213 to execute the digital content (S415). If the execution/non-execution information is execution non-authentication information, the controller 205 controls the display unit 209 so as to display a message indicating that execution of the digital content is not authenticated (S417).

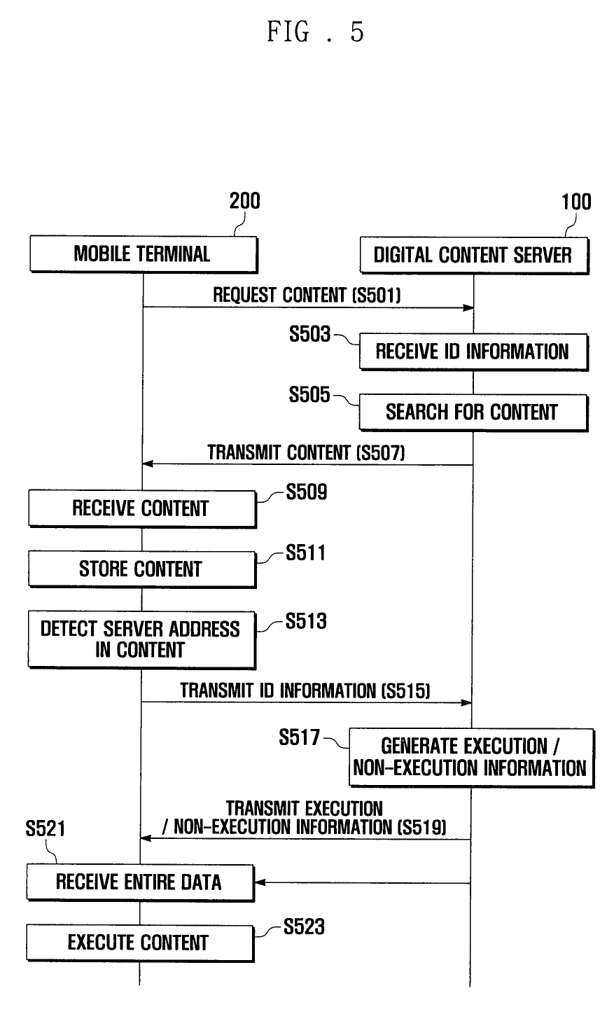

FIG. 5 is a flowchart illustrating a method for protecting copyrights of digital content according to still another exemplary embodiment of the present invention.

Referring to FIGS. 1, 2, 4, and 5, the mobile terminal 200 requests digital content from the digital content server 100 (S501). Unlike the method illustrated in FIG. 3, for example, the digital content is not already stored in the memory unit. The digital content server 100 receives unique information of the mobile terminal 200 (S503). Thereafter, the digital content server 100 searches for the digital content requested in step (S501) and matches unique information of the digital content with unique information of the mobile terminal 200 for storage (S505).

The digital content server 100 transmits the found digital content to the mobile terminal 200 (S507). The mobile terminal 200 receives the digital content from the digital content server 100 (S509) and stores the received digital content (S511). In this case, abbreviated data for the digital content is received and stored as the digital content, instead of the entire data thereof. For example, if the digital content is music content, its abbreviated data may include composer, title, artist, and other brief information.

Upon receipt of a user command to execute the digital content stored in the memory unit 207 from the input unit 211, the controller 205 detects an address of the digital content server 100 contained in the digital content (S513).

The mobile terminal 200 then transmits ID information for receiving execution/non-execution information about the digital content to the digital content server 100 having the detected address (S515).

The digital content server 100 uses the ID information received from the mobile terminal 200 at step S515 to perform authentication on the digital content and generates execution/non-execution information (S517). The execution/non-execution information represents whether the digital content is executable by the digital content server determining whether unique information of a mobile terminal that is stored matches with unique information of digital content identically with the ID information of the mobile terminal 200.

That is, the execution/non-execution information represents whether execution of the digital content is authenticated. The digital content server 100 transmits the execution/non-execution information to the mobile terminal 200 (S519). If the execution/non-execution information is execution authentication information, the mobile terminal 200 receives the entire data of digital content (S521) and executes the digital content (S523). The entire data is the whole file corresponding to the abbreviated data. For example, the entire data of music content may correspond to abbreviated data such as composer, title, and artist.

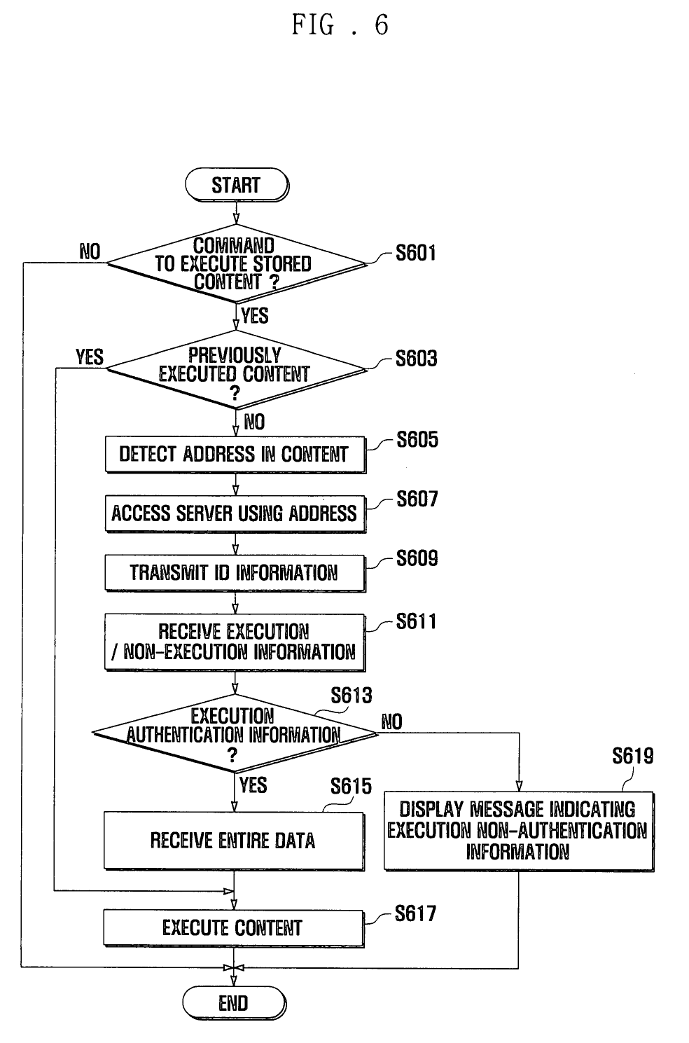

FIG. 6 is a flowchart illustrating an operation of the mobile terminal 200 in a method for protecting copyrights of digital content according to another embodiment of the present invention.

Referring to FIG. 6, if the controller 205 determines that a user command to execute the digital content stored in the memory unit 207 is input through the input unit 211 (S601), the controller 205 determines whether the digital content to be executed has been previously executed (S603). If the controller 205 determines that the digital content has been previously executed, the controller 205 executes the digital content (S617).

If the controller 205 determines that the digital content has not been previously executed at step S603, the controller 205 detects an address of the digital content server 100 contained in the digital content (S605). The digital content is not the entire data but abbreviated data including only brief information about the digital content.

The controller 205 controls the Internet module 203 to access the digital content server 100 with the detected address (S607) and transmits ID information to the digital content server 100 (S609). Thereafter, the controller 205 controls the Internet module 203 to receive execution/non-execution information about the digital content corresponding to the ID information (S611).

The controller 205 determines whether the execution/non-execution information is execution authentication information or execution non-authentication information (S613). If the execution/non-execution information is execution authentication information, the controller 205 downloads the entire data of the digital content corresponding to the abbreviated data (S615) and executes the downloaded digital content (S617).

If the execution/non-execution information is execution non-authentication information, the controller 205 controls the display unit 209 to display a message indicating that execution of the digital content is not authenticated (S619).

While the present invention has been particularly shown and described with reference to embodiments thereof, the description of the embodiments is to be construed as exemplary only and does not describe every possible instance of the invention. Therefore, it should be understood that various changes may be made and equivalents may be substituted for elements of the invention without departing from the spirit and scope of the present invention as defined by the following claims.

As described above, a system and method for protecting copyrights of digital content according to the present invention enables simple authentication of digital content by allowing a digital content server to perform authentication on the digital content. The present invention can also prevent illegal copying and hacking by allowing a digital content server to perform digital content authentication using ID information of the digital content and mobile terminal.

What is claimed is:

1. A system for protecting copyrights of digital content, comprising:
a digital content server for providing digital content including an address of the digital content server in the digital content, and in response to an authentication request, performing authentication of the digital content previously provided, and generating execution/non-execution information representing an authentication result for the digital content.

2. The system of claim 1, further comprising a mobile terminal for requesting authentication of the digital content, receiving the execution/non-execution information from the digital content server and executing the digital content according to the execution/non-execution information.

3. The system of claim 2, wherein the mobile terminal detects an address of the digital content server contained in the digital content and transmits identification (ID) information necessary for executing the digital content to the digital content server using the detected address.

4. The system of claim 3, wherein the ID information comprises unique information of the digital content and unique information of the mobile terminal.

5. The system of claim 3, wherein the digital content server performs authentication on the digital content using the ID information received from the mobile terminal and generates the execution/non-execution information representing an authentication result for the digital content.

6. The system of claim 1, wherein the execution/non-execution information comprises one of execution authentication information representing that execution of the digital content is authenticated, or execution non-authentication information representing that execution of the digital content is not authenticated.

7. The system of claim 6, wherein if the execution/non-execution information is execution non-authentication information, the mobile terminal displays a message indicating that execution of the digital content is not authenticated.

8. The system of claim 6, wherein if the execution/non-execution information is execution authentication information, the mobile terminal executes the digital content.

9. A method for protecting copyrights of digital content, comprising:
detecting, upon receiving a request to execute digital content in a mobile terminal, an address of a digital content server contained in the digital content;
accessing the digital content server using the detected address and transmitting identification (ID) information necessary for executing the digital content to the digital content server;
performing authentication of the digital content in the digital content server using the ID information, generating execution/non-execution information representing an authentication result for the digital content, and transmitting the execution/non-execution information to the mobile terminal; and
receiving the execution/non-execution information in the mobile terminal and executing the digital content according to the execution/non-execution information.

10. The method of claim 9, wherein the ID information comprises unique information of the digital content and unique information of the mobile terminal.

11. The method of claim 9, wherein the execution/non-execution information comprises one of execution authentication information representing that execution of the digital content is authenticated, or execution non-authentication information representing that execution of the digital content is not authenticated.

12. The method of claim 11, further comprising displaying by the mobile terminal a message indicating that execution of the digital content is not authenticated, if the execution/non-execution information comprises execution non-authentication information.

13. The method of claim 11, further comprising the mobile terminal executing the digital content if the execution/non-execution information comprises execution authentication information.

14. The method of claim 9, further comprising determining whether the digital content is the entire data or abbreviated data in the digital content server.

15. The method of claim 14, further comprising transmitting, if the digital content is abbreviated data, the entire data of the digital content to the mobile terminal according to the execution/non-execution information in the digital content server.

16. A method for protecting copyrights of digital content provided by a digital content server by executing the digital content in a mobile terminal, comprising:
detecting, upon receiving a request to execute the digital content in the mobile terminal, an address of the digital content server contained in the digital content;
accessing the digital content server using the detected address;
receiving execution/non-execution information related to the digital content from the digital content server; and
executing the digital content according to the execution/non-execution information.

17. The method of claim 16, further comprising:
determining whether the digital content has been previously executed;
executing, if the digital content has been previously executed, the digital content; and
detecting, if the digital content has not been previously executed, the address of the digital content server and accessing the digital content server.

18. The method of claim 16, further comprising transmitting identification (ID) information to the digital content server having the detected address for determining whether the digital content is authenticated.

19. The method of claim 18, wherein the ID information comprises unique information of the digital content and unique information of the mobile terminal.

20. The method of claim 16, further comprising determining whether the execution/non-execution information comprises one of execution authentication information or execution non-authentication information.

21. The method of claim 20, wherein executing the digital content comprises:
executing, if the execution/non-execution information comprises execution authentication information, the digital content; and
displaying, if the execution/non-execution information comprises execution non-authentication information, a message indicating that execution of the digital content is not authenticated.
